(19) United States
(12) Patent Application Publication
(10) Pub. No.: US 2013/0204518 A1
(43) Pub. Date: Aug. 8, 2013

(54) MINIMAL INFRASTRUCTURE SYSTEM AND METHOD FOR DETERMINING LANE

(71) Applicant: Michael George Melville, Albuquerque, NM (US)

(72) Inventor: Michael George Melville, Albuquerque, NM (US)

(21) Appl. No.: 13/752,039

(22) Filed: Jan. 28, 2013

Related U.S. Application Data
(60) Provisional application No. 61/594,187, filed on Feb. 2, 2012.

(51) Int. Cl. G01C 21/26

(52) U.S. Cl. CPC G01C 21/26
USPC 701/408

(57) ABSTRACT

The system utilizes a vehicle's knowledge of its own travel speed and the time between the vehicle's intersecting two light beams that issue from the same location. The light beams can be generated using a retro-reflector illuminated by the vehicle itself, or can be generated with a split beam laser or other light source located at the road side. The vehicle detects the two beams and measures the time between the two detections. Using the vehicle travel speed, it is then possible to determine the vehicle's distance from the road side equipment and thus the lane of travel of the vehicle.

### CROSS-REFERENCE TO RELATED APPLICATIONS

This utility application claims the benefit under 35 U.S.C. §119(e) of provisional application Ser. No. 61/594,187 filed on Feb. 2, 2012, entitled “Minimal Infrastructure System and Method for Determining Lane.” The entire disclosure of this provisional application is included herein by reference.

### FIELD OF THE INVENTION

The invention relates generally to the field of vehicle tracking and tolling and particularly to determination of lane of travel of a vehicle.

### BACKGROUND

In the vehicle tolling field, it is often necessary to determine in which lane of a multiple lane roadway or tolling plaza a vehicle is traveling. One reason for this is that conventional electronic toll collection equipment, such as RFID tags have response patterns that are difficult or impossible to confine to a single lane. Thus, a toll transaction for a car traveling in a first lane might be incorrectly assigned to a vehicle traveling in an adjacent lane simply because the monitoring equipment in the second lane received a signal from an RFID tag in the vehicle that is physically located in the first lane. This problem is even more acute in open road tolling applications where there are no toll booths to confine lateral vehicle position and where equipment sensitivity must be high to track fast moving vehicles.

Thus, there is a need for systems that can efficiently determine lateral vehicle position in a roadway.

### DESCRIPTION

### Summary of the Invention

In an embodiment of the invention there is a system for determination of lateral position of a vehicle traveling in a roadway. The system includes a first light source alongside the roadway at a measurement point directed at a first angle relative to a line transecting the roadway perpendicular to direction of travel. The system further includes a second light source alongside the roadway at the measurement point directed at a second angle relative to a line at a transecting the roadway perpendicular to direction of travel. The system further includes a light detector in the vehicle for detecting the first and second light sources; a speed detector in the vehicle; a microcomputer in the vehicle with inputs for the speed detector and light detector. In the system, the second angle is less than the first angle; the light detector detects the first light source at a first time and indicates the first detection to the microcomputer, the light detector detects the second light source at a second time and indicates the second detection to the microcomputer; and the microcomputer calculates the lateral position of the vehicle at the measurement point. In a further embodiment, the first and second light sources are retro-reflectors, further comprising a third light source in the vehicle directed to the retro-reflectors. In a further embodiment, the said first and second light sources are collimated light beams.

### DESCRIPTION OF THE DRAWINGS

FIG. 1 is a diagram of a vehicle approaching a dual retro-reflector in accordance with one aspect of the invention.

FIG. 2, is a diagram of a vehicle which has intersected a first reflected light ray.

FIG. 3, is a diagram of a vehicle which has intersected a second reflected light ray.

### DETAILED SPECIFICATION

This method uses a minimal amount of road side equipment to help determine the lane of travel of a vehicle. Its intended purpose is to help determine if a vehicle is in a tolled lane or not, thereby allowing the system to charge the correct vehicle for using the toll lane.

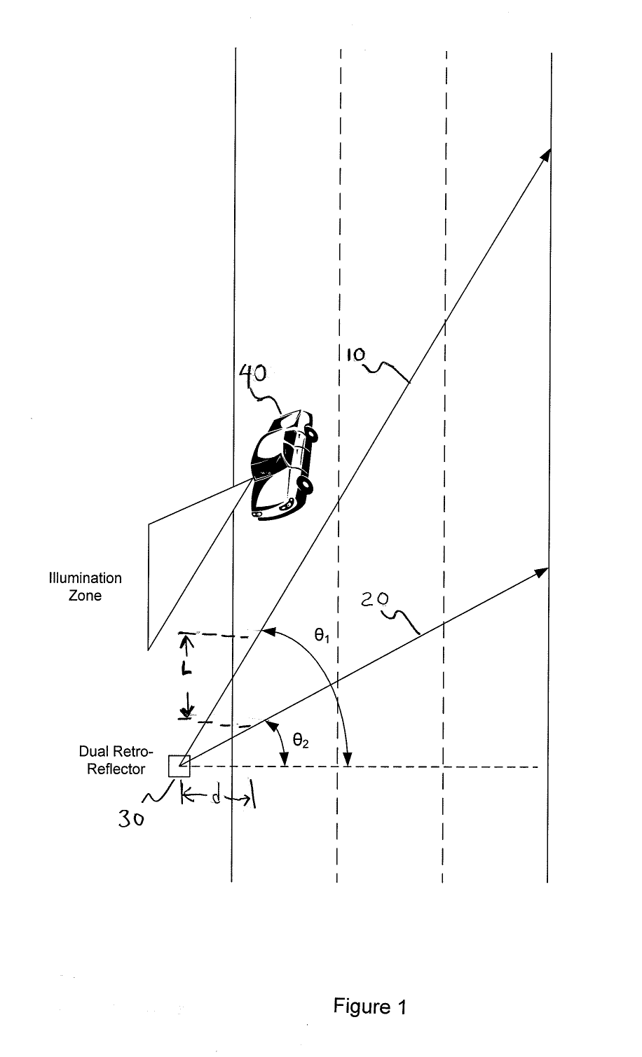

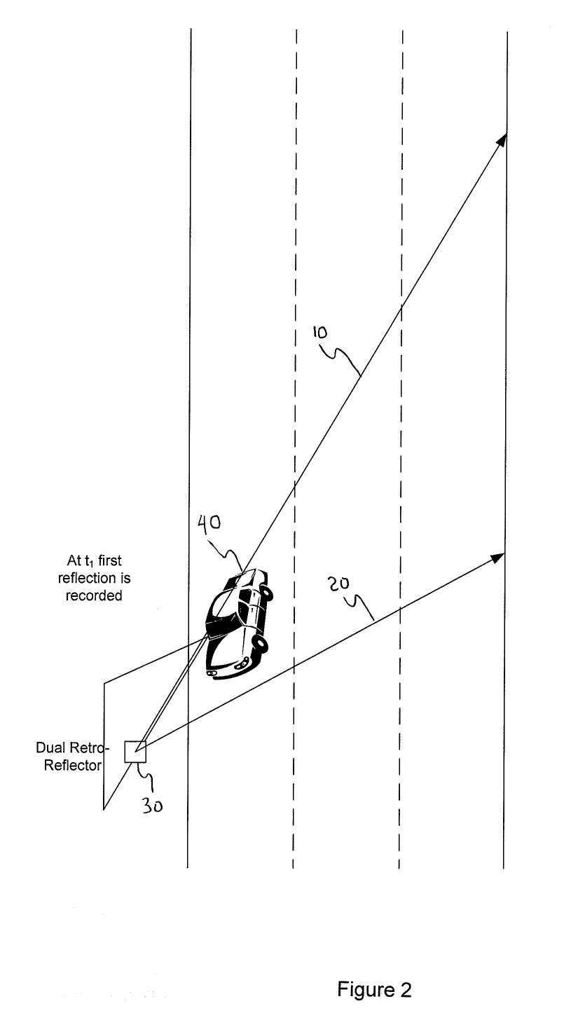

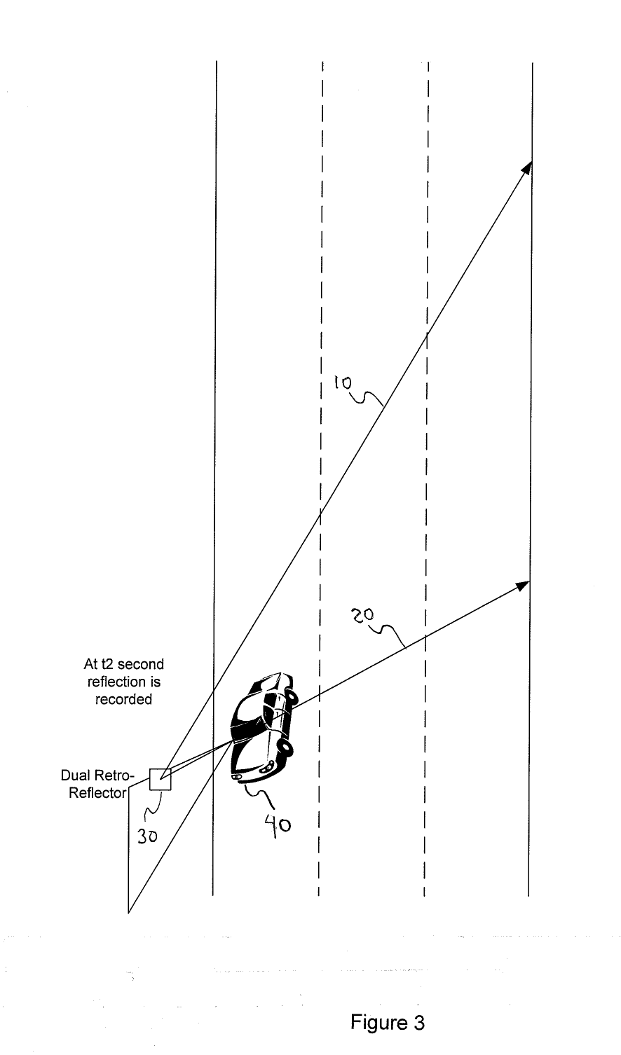

The system utilizes the vehicle's knowledge of its own travel speed and the time between the vehicle's intersecting two light beams that issue from the same location. As shown in FIG. 1, the light beams 10, 20 can be generated using a retro-reflector 30 illuminated by the vehicle 40 itself, or can be generated with a split beam laser or other light source (not shown) located at the road side. The vehicle detects the two beams (FIGS. 2 and 3) and measures the time between the two detections. Using the vehicle travel speed, it is then possible to determine the vehicle's distance from the road side equipment.

As long as the distance to the lane from the road side equipment is known the system can determine the lane of travel, by calculating the distance from the road side equipment. The benefit from this system is the minimal amount of road side equipment required to determine the lane of travel, in that the lateral distance determination is made by equipment in the vehicle, which may for instance be dashboard or rearview mirror mounted sensors and electronics associated with an on board RFD device for communicating with roadway toll equipment. The vehicle lateral position is determined by the on board equipment as described above and transmitted to the roadway toll equipment with the same on board devices currently known for vehicle identification for tolling purposes, including backscatter and active transmission devices.

With respect to FIGS. 1-3:

d=right angle distance to reflector or light source.

Θ₁=angle to first beam

Θ₂=angle to second beam

v=velocity of vehicle

t=time between sensing of sources

L=length of road surface between beams

L=v*t, velocity times time equals length

d=L/(tan θ₁−tan θ₂)

In the following example,

θ₁=60 degrees

θ₂=30 degrees

v=68.2 mph; 100 ft/sec

t (time between intersection of first and second beams)=138 ms;

L=0.138*100=13.8 ft

d=13.8/(tan(60)−tan(30))=12 ft

In this example, the vehicle is 12 ft from the source when it is at a right angle to the source.

While certain representative embodiments and details have been shown for purposes of illustrating the invention, it will be apparent to those skilled in the art that various changes in the methods and apparatus disclosed herein may be made without departing from the scope of the invention.

1. A system for determination of lateral position of a vehicle traveling in a roadway comprising:
a first light source alongside the roadway at a measurement point directed at a first angle relative to a line transecting said roadway perpendicular to direction of travel;
a second light source alongside the roadway at said measurement point directed at a second angle relative to a line at a transecting said roadway perpendicular to direction of travel;
a light detector in the vehicle for detecting said first and second light sources;
a speed detector in the vehicle;
a microcomputer in the vehicle with inputs for said speed detector and light detector;
wherein, said second angle is less than said first angle;
said light detector detects said first light source at a first time and indicates said first detection to said microcomputer,
said light detector detects said second light source at a second time and indicates said second detection to said microcomputer; and
wherein said microcomputer calculates the lateral position of the vehicle at said measurement point.

2. The system of claim 1, wherein said first and second light sources are retroreflectors, further comprising a third light source in the vehicle directed to said retroreflectors.

3. The system of claim 2, wherein said first and second light sources are collimated light beams.

4. A method for determination of lateral position of a vehicle traveling in a roadway comprising:
producing a first light source alongside the roadway at a measurement point directed at a first angle relative to a line transecting said roadway perpendicular to direction of travel;
producing a second light source alongside the roadway at said measurement point directed at a second angle relative to a line at a transecting said roadway perpendicular to direction of travel;
detecting said first light source in the vehicle at a first detection time
detecting said second light source in the vehicle at a second detection time
detecting vehicle speed in the vehicle
wherein, said second angle is less than said first angle;
calculating the distance the vehicle travelled between the first and second detection times; and
calculating the lateral position of the vehicle at said measurement point based on said distance and said first and second angles.

5. The method of claim 4, wherein said first and second light sources are retroreflectors and further comprising illuminating said retroreflectors from the vehicle.
